(19) United States
(12) Patent Application Publication
(10) Pub. No.: US 2026/0187745 A1
(43) Pub. Date: Jul. 2, 2026

(54) EMBEDDING A DIGITAL WATERMARK IN STYLUS PEN INK

(71) Applicant: Microsoft Technology Licensing, LLC, Redmond, WA (US)

(72) Inventors: Roei Shlomo MENASHOF, Netanya (IL); Oren ISTRIN, Tel Aviv (IL); Netanel HADAD, Lod (IL)

(73) Assignee: Microsoft Technology Licensing, LLC, Redmond, WA (US)

(21) Appl. No.: 19/006,915

(22) Filed: Dec. 31, 2024

(51) Int. Cl. G06T 1/00; G06F 3/04883; G06F 21/32; G06F 21/60

(52) U.S. Cl. CPC G06T 1/0021; G06F 3/04883; G06F 21/32; G06F 21/602

(57) ABSTRACT

Methods and systems for embedding a digital watermark in a stylus pen ink. A method for embedding a digital watermark in a stylus pen ink by a digitizer comprises detecting a touch from a stylus pen on a display of the digitizer, determining a user identification, wherein the user identification is linked to the digital watermark, and based at least on the touch from the stylus pen on the display, displaying the stylus pen ink on the display, the stylus pen ink embedding the digital watermark as a pattern of pixels.

### BACKGROUND

Some electronic devices, such as laptop and tablet computers, can utilize a stylus pen as an input device. A stylus pen can enable user interactions with a touch-screen display on such devices. Example user interactions can include writing notes and signing documents.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides a method for embedding a digital watermark in a stylus pen ink by a digitizer. The method comprises detecting a touch from a stylus pen on a display of the digitizer, determining a user identification, wherein the user identification is linked to the digital watermark, and based at least on the touch from the stylus pen on the display, displaying the stylus pen ink on the display, the stylus pen ink embedding the digital watermark as a pattern of pixels.

### BRIEF DESCRIPTION OF THE DRAWINGS

FIG. 1 schematically shows an example embedded watermark in a stylus pen ink.

FIG. 2 schematically shows an example computing system and stylus pen.

FIG. 3 shows a flowchart of an example method for embedding a digital watermark.

FIG. 4 shows a flowchart of an example process for detecting and verifying an embedded watermark.

FIG. 5 shows a block diagram of an example computing system.

### DETAILED DESCRIPTION

Stylus pens can be used for a variety of computer interactions, including digital transactions and document creation/editing, that can involve user authentication. User authentication can enable a stylus pen inking to be verified as being made by a particular user. Verifying the user can help enhance trust in digital transactions and document authentication.

However, authenticating stylus pen inkings as being made by a particular user can be challenging. One possible way to authenticate stylus pen inkings is to determine the owner of the stylus pen, such as by registering a stylus pen for a particular owner. However, if different users use the same stylus pen, it can be difficult to determine who is using the stylus pen when a stylus pen inking is made, as the user interaction would appear the same regardless of the user using the stylus pen. As the use of stylus pens to draft or sign documents increases, there is a need for a secure and robust way to identify and authenticate the user of the stylus pen.

Accordingly, examples are disclosed for embedding a digital watermark in a stylus pen inking to show authentication of a user who made the stylus pen inking. Briefly, a stylus pen and/or a digitizer includes sensors that can sense biometric information for current users of the stylus pen. When the stylus pen is used, a digitizer (a device configured to receive stylus pen inputs) detects a touch from a stylus pen on a display of the digitizer and receives sensed biometric information. The digitizer then determines a user identification using the biometric information, retrieves a digital watermark linked to the user identification, and displays the stylus pen ink encoding the digital watermark as a pattern of pixels. The digital watermark can be embedded at a pixel level within the digital ink such that the embedded watermark is invisible to the naked eye, but can be decoded from the pixel level data. Having the digital watermark invisible to the naked eye can help ensure there is no effect on the appearance or performance of the digital ink, while providing a way to authenticate the user of the stylus pen. The embedded watermark can be designed to withstand digital transformations like resizing, compression, or format conversion. As the digital watermark is linked to the user’s profile, the digital watermark can help to ensure each stylus pen stroke’s authenticity by providing a unique link to a user.

Further examples are disclosed that relate to a stylus pen for user recognition using biometric information. Briefly, the stylus pen comprises one or more biometric sensors, including at least a fingerprint sensor, to collect biometric data, and a communication device for transferring the biometric data collected by the one or more biometric sensors to a digitizer. Inclusion of sensors on the stylus pen enables biometric data to be collected for each user of the stylus pen, such that each user’s biometric data can be linked to a digital watermark for identification purposes. Further, the biometric data collected can be encrypted, which can help to further privacy and security benefits by protecting the information and preventing unauthorized access.

Examples are also disclosed that relate to detecting and verifying embedded watermarks through authorized software. Having the embedded watermark only detectable by authorized software can help improve security by controlling who is able access to the watermark data, which can reduce a likelihood of the watermark being counterfeited. Further, the verification process can help to authenticate embedded watermarks by cross referencing the detected embedded watermark with those in stored user profiles.

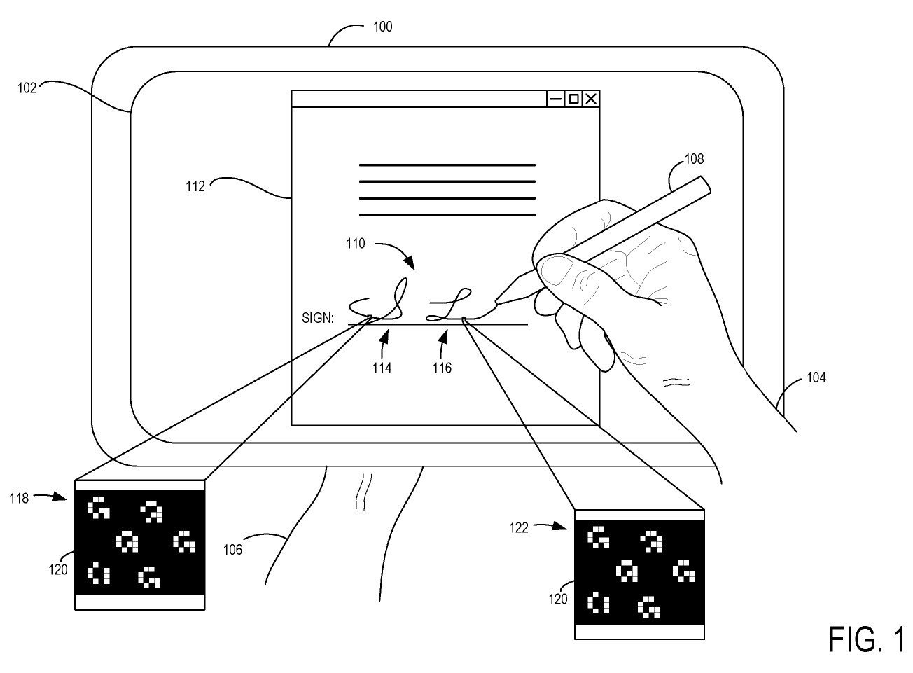

FIG. 1 shows an example digitizer 100 with a touch-sensitive display 102 according to aspects of the present disclosure. In the present example, digitizer 100 comprises a tablet device configured to be held in one or both hands 104 and 106 of a user. In other examples, other computing devices with touch-sensitive displays can be utilized (e.g., a smartphone or laptop device).

In the present example, a stylus pen 108 is held in user hand 104, such that the user can use the stylus pen to write with stylus pen 108 a digital signature 110 on a document window 112 displayed on touch-sensitive display 102. The digital signature 110 comprises a first inking 114 that is displayed on touch-sensitive display 102 based at least on a first touch from the stylus pen 108. The digital signature 110 further comprises a second inking 116 that is displayed on touch-sensitive display 102 based at least on a second touch from the stylus pen 108.

Stylus pen 108 can authenticate the user using biometric data such as a fingerprint pattern, grip pattern, motion patterns, iris scans, and/or voice recognition. Fingerprint patterns can help to increase the accuracy at which the user is authenticated compared to other biometric data, as fingerprint patterns can be more unique than grip or motion patterns, and can be sensed without access to a microphone or a camera that would be used respectively for sensing voice or iris patterns. In some examples, the biometric data can be collected by sensor(s) included on a stylus pen. In such examples, the stylus pen 108 can communicate the biometric data to the digitizer 100, which can then compare the collected biometric data to stored biometric data to determine a user identity that is linked to a digital watermark. In other examples, the biometric data alternatively or additionally can be collected by sensor(s) on the digitizer. The digitizer can compare the collected data to stored biometric data to determine a user identity that is linked to a digital watermark. After determining the user identification, the watermark linked to the user identification can be embedded in the stylus pen ink. Once the digital watermark is embedded in digital signature 110, the digital watermark can be detected and verified by digitizer 100 to authenticate the digital signature 110.

A first magnified view 118 of the first inking 114 shows stylus pen 108 ink with an embedded watermark 120. A second magnified view 122 of the second inking shows stylus pen 108 ink with the embedded watermark 120. The embedded watermark 120 is encoded as a pattern of pixels that is embedded in the stylus pen ink. The digital watermark can be embedded in the displayed stylus pen inkings in any suitable manner. As one example, the digital watermark can comprise frequency domain information that is transformed to spatial domain information by using a transform such as an inverse discrete wavelet transform. In other examples, any suitable transform can be used to embed the digital watermark in the stylus pen ink. Embedding the watermark at pixel level can help to ensure that the visual quality of the digital signature is maintained by not having the digital watermark visible to the naked eye. The embedded watermark 120 is linked to the user of stylus pen 108 such that it identifies the user as the writer of the of the first inking 114 and the second inking 116 of digital signature 110. Embedding the embedded watermark 120 allows the authenticity of the first inking and the second inking to be determined both by a computer program accessing the pixel data in the inking file, as well as by using a camera to acquire an image of a display that is displaying the embedded watermark, and then processing the pixel data of the image.

As shown, both the first inking 114 and the second inking 116 have the digital watermark embedded in the inking such that each inking can be authenticated and linked to the user. Embedding the digital watermark in each inking can help to reduce the likelihood of the digital signature being forged, when compared to only one inking of a set of related inkings (e.g., letters of a signature) having the digital watermark embedded.

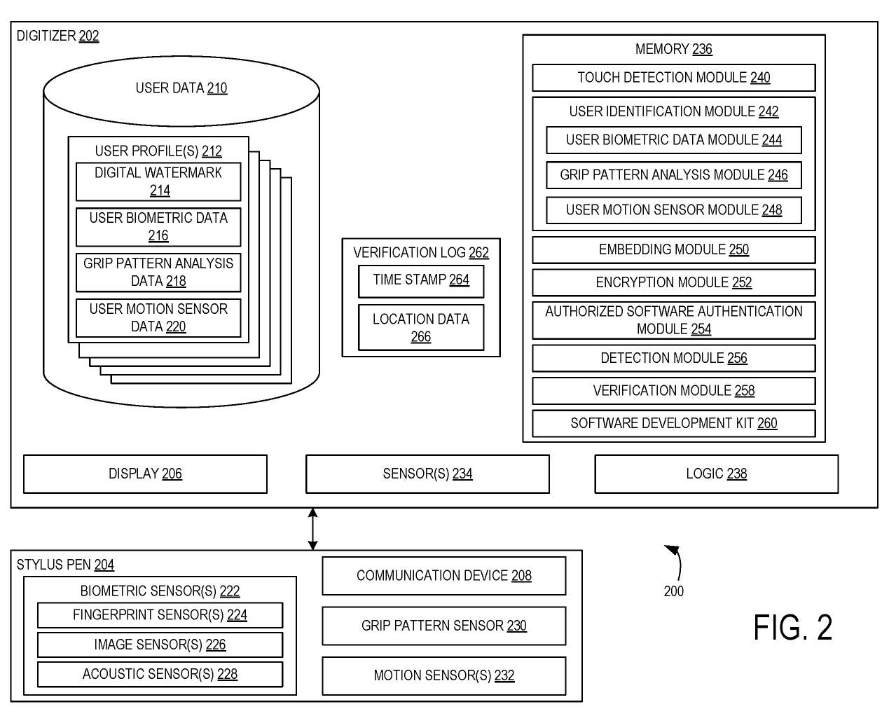

FIG. 2 shows an example computing system 200. Computing system 200 includes a digitizer 202 and a stylus pen 204. Computing system 200 is configured for embedding, detecting, and verifying an embedded digital watermark in displayed stylus pen ink. Digitizer 100 and stylus pen 108 of FIG. 1 are examples of digitizer 202 and stylus pen 204, respectively. Digitizer 202 includes display 206. In some examples, display 206 can comprise a touch-screen capable of detecting touches from stylus pen 204. Touch-sensitive display 102 is an example of display 206. In other examples, display 206 can be paired with a separate touch sensor (e.g., a track pad) that can detect touches from a stylus pen to be displayed on display 206. Stylus pen 204 includes communication device 208, which enables stylus pen 204 to communicate with digitizer 202. For example, communication device 208 can transfer data collected by sensors on stylus pen 204 to digitizer 202.

Digitizer 202 includes a storage subsystem storing user data 210. User data 210 includes a plurality of user profile(s) 212. Each user profile 212 comprises a stored digital watermark 214 and stored user identification data. The user identification data can include user biometric data 216. In some examples, user biometric data 216 can include one or more of fingerprint data, iris scan data, or voice recognition data. In other examples, one or more other types of biometric data alternatively or additionally can be stored. Further, in some examples, behavioral biometrics data alternatively or additionally can be stored. The term “behavioral biometrics” as used herein indicates unique user behaviors a user exhibits when using a stylus pen. In such examples, the behavioral biometrics can include grip pattern analysis data 218, and/or user motion sensor data 220 that is indicative of writing speed, pressure, sensitivity, an angle at which the stylus pen is held, and/or other behavioral biometric data. In further examples, user biometric data 216 may include any other suitable biometric data that can be used to identify the user of a stylus pen.

In the depicted example, stylus pen 204 includes one or more biometric sensor(s) 222, such as one or more fingerprint sensor(s) 224, one or more image sensor(s) 226, and/or one or more acoustic sensor(s) 228. In such examples, the one or more biometric sensor(s) 222 can sense user biometric data 216, and communication device 208 can be used to transmit the collected biometric user data to be stored in and/or compared to previously stored data in user profile 212. In other examples, other suitable sensors alternatively or additionally can be used to collect biometric user data.

The one or more fingerprint sensor(s) 224 can collect a stylus pen user’s fingerprint pattern and communication device 208 can transmit the fingerprint pattern to digitizer 202. Each fingerprint sensor of the one or more fingerprint sensor(s) 224 can comprise any suitable type of sensor. Examples include capacitive fingerprint sensors and optical fingerprint sensors. Likewise, the one or more image sensor(s) 226 can acquire an image of a user’s eye, and communication device 208 can transmit the image data to digitizer 202 for iris analysis. The image sensor(s) 226 can be positioned on a stylus pen in a location that can image the user’s eye as the user contacts the stylus pen to the digitizer and that is not occluded by the user’s hand during use, such as adjacent to or at an end of the stylus pen opposite the end that contacts the digitizer display. Further, the one or more acoustic sensor(s) 228 can comprise microphones that collect samples of a stylus pen user’s voice. Communication device 208 can transmit the samples to digitizer 202.

In some examples, grip pattern analysis data 218 can include grip patterns that indicate how a user holds a stylus pen. As such, stylus pen 204 can include a grip pattern sensor 230 that can collect grip pattern analysis data 218. In some examples, the grip pattern sensor 230 can be implemented as the one or more fingerprint sensor(s) 224. In other examples, the grip pattern sensor 230 can comprise one or more touch sensors that are distinct from the one or more fingerprint sensor(s) 224. Communication device 208 can be used to transmit the collected grip pattern analysis data to be stored in user profile 212.

In some examples, user motion sensor data 220 can include writing patterns unique to the user. Stylus pen 204 thus can include one or more motion sensor(s) 232 that can collect user motion sensor data 220. In some examples, the one or more motion sensor(s) 232 can comprise inertial motion sensors. In such examples, the inertial motion sensors can include gyroscopes and accelerometers. In further examples, the one or more motion sensor(s) 232 alternatively or additionally can comprise any other suitable type of motion sensor, such as an optical motion sensor. Communication device 208 can be used to transmit the collected motion sensor data to be stored in user profile 212. Such motion sensor data then can be compared to stored motion patterns for a user (e.g., by identifying letters represented by the motion data, extracting motion features from the letters, and comparing them to stored motion features for the user).

Depending upon the form of a digitizer, alternatively or additionally to the sensors on the stylus pen 204, sensor(s) on the digitizer can be used to authenticate a current user of a stylus pen. As such, digitizer 202 can include one or more sensor(s) 234 useable to sense data indicative of a user identity. In some examples, sensor(s) 234 can comprise biometric sensors. Example biometric sensors can include one or more of a fingerprint sensor (e.g., capacitive fingerprint sensors and/or optical fingerprint sensors), an image sensor, or an acoustic sensor. Further, in such examples, the biometric data collected from the sensor(s) 234 can be stored in user profile(s) 212. In other examples where the computing device comprises a tablet form, the sensor(s) 234 can comprise grip pattern sensors, capable of collecting grip pattern analysis data. In such examples, the grip pattern analysis data collected by sensor(s) 234 can be stored in user profile(s) 212. In even further examples where the computing device comprises a tablet form, sensor(s) 234 can comprise one or more motion sensor(s) capable of collecting user motion sensor data. In such examples, the sensor(s) 234 can comprise inertial motion sensors (e.g., accelerometers and gyroscopes). Further, in such examples, the user motion sensor data collected by sensor(s) 234 can be stored in user profile(s) 212.

The digital watermark 214 can be stored in user profile 212 in any suitable form that enables the digital watermark to be embedded in a stylus pen’s ink. In some examples, digital watermark 214 can be stored in its native form. In other examples, the digital watermark 214 can be stored as a hashed version. In such examples, a digital watermark that is read from an inking can be hashed to compare to the stored digital watermark. In further examples, the digital watermark 214 can be stored in any other suitable format.

Digitizer 202 further includes memory 236 that is configured to store instructions to be executed by logic 238. Memory 236 includes instructions for executing a touch detection module 240. Touch detection module 240 is configured to detect touches on display 206 of digitizer 202 and display stylus pen ink after detecting a touch from the stylus pen 204.

Memory 236 further includes instructions for executing a user identification module 242. User identification module 242 is configured to perform user identification for the user of stylus pen after the touch detection module 240 detects a touch on display 206. User identification module 242 includes user biometric data module 244 to allow user identification module 242 to use user biometric data to determine a user identification. User biometric data module 244 can be configured to collect user biometric data 216 using one or more sensor(s), store the collected user biometric data, and link the user biometric data to a user profile such that the collected user biometric data is stored in a user profile. In some examples, the biometric user data can include one or more of fingerprint data, iris scan data, or voice recognition data. In other examples, the user biometric data module 244 can alternatively or additionally collect, store, and link one or more other suitable types of biometric data.

In still further examples, the user biometric data module 244 alternatively or additionally can collect and store behavioral biometrics data and link the behavioral biometrics data to a user profile. For example, user identification module 242 can include grip pattern analysis module 246 to allow user identification module 242 to use grip pattern analysis data to determine a user identification. Grip pattern analysis module 246 can be configured to collect grip pattern analysis data 218 using a grip pattern sensor, store the collected user grip pattern analysis data, and link the grip pattern data to a user profile such that the collected user grip pattern data is stored in a user profile. The grip pattern sensor can comprise any suitable type of an arrangement of touch sensor(s).

User identification module 242 further includes user motion sensor module 248, such that user identification module 242 can use user motion sensor data to determine a user identification. User motion sensor module 248 is configured to collect user motion sensor data 220 using one or more motion sensor(s), store the collected user motion sensor data, and link the motion sensor data to a user profile such that the collected user motion sensor data is stored in a user profile. The one or more motion sensors can include one or more of inertial motion sensors (e.g., a gyroscope or accelerometer) or any other suitable motion sensor, such as an optical motion sensor.

Memory 236 further includes instructions executable to operate an embedding module 250. Embedding module 250 is configured to embed the digital watermark in a stylus pen ink. Embedding module 250 can embed the digital watermark in a stylus pen ink in any suitable manner. In some examples, the digital watermark can comprise frequency domain information that is transformed by embedding module 250 to spatial domain information. In such examples, embedding module 250 can utilize an inverse discrete wavelet transform to embed the digital watermark in pixel data representing the stylus pen ink. Prior to embedding, the pixel data representing the stylus pen ink can be transformed using a discrete wavelet transform, and then combined with data representing the digital watermark. Then, the inverse discrete wavelet transform can be used to produce the stylus pen ink encoding the digital watermark. In other examples, any other suitable transform can be used to embed the digital watermark in the stylus pen ink. Embedding module 250 can embed the digital watermark at a pixel level within the stylus pen ink, such that the embedded watermark is represented by a pattern of pixels.

Memory 236 further includes instructions executable to operate an encryption module 252. Encryption module 252 is configured to encrypt data such as the digital watermark and user identification data using any suitable encryption protocol or protocols. The user identification data can include one or more of user biometric data 216, grip pattern analysis data 218, user motion sensor data 220, or any other suitable type of data that is unique to a user. In some examples, the encryption protocol can comprise Advanced Encryption Standard 256 (AES-256). In other examples, any other suitable encryption protocol can be utilized to encrypt the watermark and user identification data.

Memory 236 further includes instructions for executing authorized software authentication module 254. Authorized software authentication module 254 is configured to determine whether an application attempting to detect and verify an embedded watermark is an approved application. As used herein, an “approved application” indicates a user application that has embedded watermark detection and verification capabilities that have been authenticated and approved by a relevant entity. By only allowing approved applications to detect and verify the watermark, the authorized software module can help increase the security of the watermark data when compared to allowing unauthorized applications to access these capabilities.

Memory 236 further includes instructions for executing detection module 256 to implement a detection algorithm. Detection module 256 is configured to detect the embedded watermark after the authorized software authentication module 254 determines the application is an approved application. Detection module 256 can detect the embedded watermark by processing the pixel data in the inking file. Alternatively or additionally, detection module 256 can detect the embedded watermark by using a camera to acquire an image of a display that is displaying the embedded watermark, and then processing the pixel data of the image. For example, in a digital transaction a user may digitally sign a document using software configured to embed the digital watermark as a pattern of pixels. The signed document can be sent to a recipient. The recipient can then use an authorized software to detect the embedded watermark from the pixel data of the digital signature, or of an image of the displayed watermark, to confirm the authenticity of the digital signature on the document.

In some examples, the embedded watermark can comprise spatial domain information that can be transformed to frequency domain information using a suitable transform to recover the digital watermark from the image. In some examples, the detection module 256 can utilize a discrete wavelet transform (DWT). The DWT can break a detected signal into different frequency components such that the watermark and any noise can be distinctly identified. Further, the DWT can be effective for watermark detection at varying resolution levels, which can help increase the robustness of the digital watermark compared to methods with detection at smaller ranges of resolution levels.

Memory 236 further includes instructions for executing verification module 258. Verification module 258 is configured to cross-reference the embedded watermark that is detected using the detection module 256 with the digital watermark(s) that are stored in user profile(s) 212. In some examples, verification module 258 can comprise a hash-based matching algorithm that uses cryptographic hash functions to help ensure that the detected embedded watermark matches the watermark stored in user profile(s) 212. In other examples, any other suitable method can be used for cross-referencing the embedded watermark with digital watermarks stored in user profiles.

Memory 236 further can store executable code of a software development kit 260. Such code can be configured to integrate detection and verification capabilities into an application that supports stylus pen inkings.

Digitizer 202 further includes verification log 262. Verification log 262 includes time stamps 264 and location data 266. Time stamps 264 can help a user to determine when stylus pen ink with the user’s digital watermark was authenticated. Location data 266 comprises data regarding a location at which the stylus pen ink with the user’s digital watermark was authenticated. The verification log provides further security for the digital watermark, as it can help to verify if a user’s embedded watermark was verified accurately.

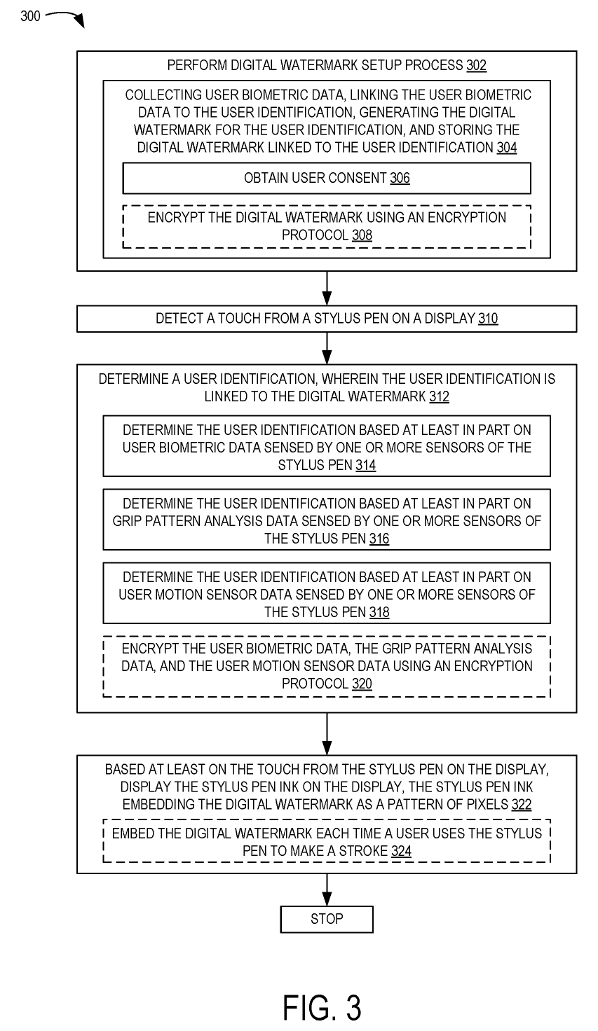

FIG. 3 shows a flow diagram illustrating an example method 300 for embedding a digital watermark in a stylus pen ink. Method 300 can be implemented on digitizer 202 and stylus pen 204 of FIG. 2, as examples. Method 300 comprises, at 302, performing a digital watermark setup process. The digital watermark setup process comprises, at 304, collecting user biometric data, linking the user biometric data to the user identification, generating the digital watermark for the user identification, and storing the digital watermark linked to the user identification.

In some examples, the biometric user data can include one or more of fingerprint data, iris scan data, or voice recognition data. In other examples, one or more other types of biometric data alternatively or additionally can be stored. Further, in some examples, behavioral biometrics data alternatively or additionally can be stored. In such examples, the behavioral biometrics can include grip pattern data, and/or motion sensor data that is indicative of writing speed, pressure, sensitivity, an angle at which the stylus pen is held, and/or other behavioral biometric data. In further examples, biometric user data may include any other suitable biometric data that can be used to identify the user of a stylus pen.

In some examples, the biometric data can be collected using one or more sensor(s) on a stylus pen. The one or more sensor(s) can include one or more biometric sensor(s), such as one or more fingerprint sensor(s), one or more image sensor(s), and/or one or more acoustic sensor(s). Each fingerprint sensor of the one or more fingerprint sensors can comprise any suitable type of sensor. Examples include capacitive fingerprint sensors and optical fingerprint sensors. Further, the one or more acoustic sensor(s) 228 can comprise microphones that collect samples of a stylus pen user’s voice.

In some examples, storing the biometric data comprises anonymizing the biometric data. Anonymizing the biometric data can help to increase the security of the stored biometric data compared to biometric data that is not anonymized before storage.

At 306, method 300 comprises obtaining user consent for the use of the biometric data collected at step 304. Obtaining user consent allows the collected biometric data to be linked to the user identification used to generate the digital watermark, and to be stored only upon user authorization.

At 308, method 300 optionally comprises encrypting the digital watermark using an encryption protocol. For example, the encryption protocol can comprise AES-256. In other examples, any other suitable encryption protocol can be used.

At 310, method 300 comprises detecting a touch from a stylus pen on a display. At 312, method 300 comprises determining a user identification, wherein the user identification is linked to the digital watermark. In some examples, determining the user identification comprises, at 314, determining the user identification based at least in part on user biometric data sensed by one or more sensors of the stylus pen. In some examples, the biometric user data can include one or more of fingerprint data, iris scan data, or voice recognition data. In other examples, the biometric user data can include one or more other types of biometric data that are sufficiently unique to a user of a stylus pen to authenticate the user (possibly in combination with other data). In even further examples, the user biometric data can include behavioral biometrics data.

The one or more sensor(s) of the stylus pen can include one or more biometric sensor(s), such as one or more fingerprint sensor(s), one or more image sensor(s), and/or one or more acoustic sensor(s). Each fingerprint sensor of the one or more fingerprint sensors can comprise any suitable type of sensor. Examples include capacitive fingerprint sensors and optical fingerprint sensors. Further, the one or more acoustic sensor(s) can comprise microphones that collect samples of a stylus pen user’s voice. Alternatively or additionally, biometric data sense by one or more sensor(s) on the digitizer can be used to determine the user identification.

In some examples, determining the user identification further comprises, at 316, determining the user identification based at least in part on grip pattern analysis data sensed by one or more sensors of the stylus pen. For example, grip pattern analysis data can include grip patterns that indicate the geometric relationship between a user’s fingers when a user holds a stylus pen and finger touch patterns as sensed by the grip sensor. In some examples, the one or more sensors of the stylus pen can comprise a grip pattern sensor. In such examples, the grip pattern sensor can comprise one or more touch sensors. The touch sensors can be included in another sensor (e.g., a fingerprint sensor) or can be included as a separate sensor.

In some examples, determining the user identification further comprises, at 318, determining the user identification based at least in part on user motion sensor data sensed by one or more sensors of the stylus pen. For example, user motion sensor data can include writing patterns sufficiently unique to the user. In some examples, the one or more sensors of the stylus pen can include one or more motion sensor(s) that can collect user motion sensor data. As a specific example, the one or more motion sensor(s) can comprise inertial motion sensors. In such examples, the inertial motion sensors can include gyroscopes and accelerometers. In further examples, the one or more motion sensor(s) can comprise any other suitable type of motion sensor, such as an optical motion sensor.

At 320, method 300 optionally comprises encrypting the user biometric data, the user grip pattern analysis data, and the user motion sensor data using an encryption protocol. For example, the encryption protocol can comprise AES-256. In other examples, any other suitable encryption protocol can be used.

Method 300 further comprises, at 322, based at least on the touch from the stylus pen on the display, displaying the stylus pen ink on the display, the stylus pen ink embedding the digital watermark as a pattern of pixels. The digital watermark can be embedded in the displayed stylus pen ink in any suitable manner. As one example, the digital watermark can comprise frequency domain information that is transformed to spatial domain information by using a transform such as an inverse discrete wavelet transform. In other examples, any suitable transform can be used to embed the digital watermark in the stylus pen ink. Embedding the watermark at pixel level can help to ensure that the visual quality of the digital signature is maintained by not having the digital watermark visible to the naked eye.

At 324, method 300 can optionally comprise embedding the digital watermark each time a user uses the stylus pen to make a stroke. The term “a stroke” as used herein indicates that a stylus pen has touched and been lifted from a display or touch sensor. As a specific example, a stroke can include writing a letter or a portion of a letter. Embedding the watermark at each stroke can help to increase the reliability of the authentication of the user, as each stroke will be uniquely linked to a user.

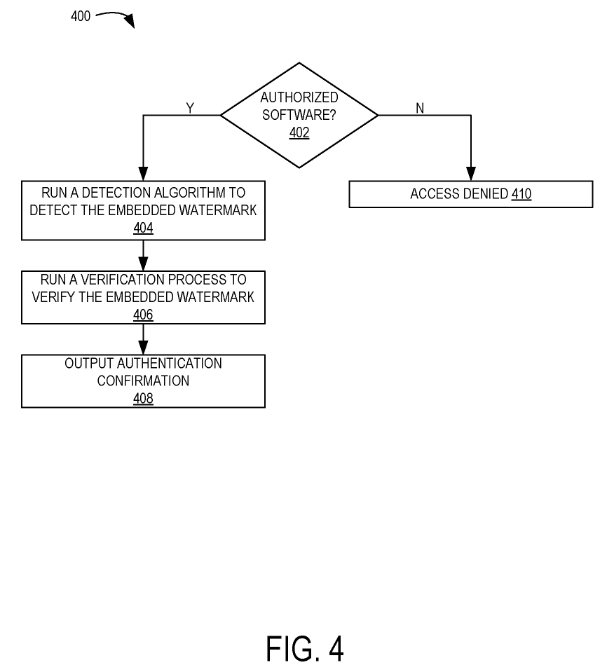

Once the digital watermark has been embedded into the stylus pen ink, detection and verification processes can be used to detect the embedded watermark and verify the authenticity of the embedded watermark. FIG. 4 shows a flowchart of an example process 400 for detecting and verifying an embedded watermark. In some examples, process 400 can be implemented on digitizer 202 of FIG. 2 to detect and verify an embedded watermark in stylus pen ink from stylus pen 204 of FIG. 2.

At 402, process 400 determines whether an application that is being used by a user of a stylus pen is an authorized software. If the application is an authorized software then process 400 continues to step 404. At 404, process 400 comprises running a detection algorithm to detect the embedded watermark. For example, detection module 256 of FIG. 2 can be used to detect the embedded watermark. In some examples, the embedded watermark can comprise spatial domain information that is transformed to frequency domain information using a suitable transform to recover the digital watermark from the image. In some examples, the transform can comprise a DWT. In other examples, any suitable transform can be utilized.

After detecting the embedded watermark, at 406, process 400 comprising running a verification process to verify the embedded watermark. Verification module 258 of FIG. 2 is an example verification process. The verification process is configured to cross-reference the embedded watermark that is detected at step 404 with digital watermarks that are stored in user profiles. In some examples, the verification process can comprise a hash-based matching algorithm that uses cryptographic hash functions to help ensure that the detected embedded watermark matches the watermark stored in a user profile. In other examples, any suitable method can be used for cross-referencing the embedded watermark with digital watermarks stored in user profiles.

After the embedded watermark has been verified, at 408, process 400 comprises outputting an authentication confirmation. In some examples, the authentication confirmation outputs a notification that indicates the inkings in a document have been detected and verified. As a specific example, the recipient of a document with a digital signature in a digital transaction can be notified that the digital signature has been verified as being made by a particular user.

However, if at step 402, the application is determined to not be an authorized software, access to the embedded watermark is denied at step 410 such that the embedded watermark cannot be detected or verified.

Accordingly, current users of a stylus pen making stylus pen inkings can be identified and linked to the stylus pen inkings for each stroke the user makes. Linking the user identification to the stylus pen inkings for each stroke enables each stroke to be authenticated and verified as being made by a particular user. Authenticating and verifying can help to increase trust in user inputs when compared to user inputs that are not authenticated or verified.

In some embodiments, the methods and processes described herein may be tied to a computing system of one or more computing devices. In particular, such methods and processes may be implemented as a computer-application program or service, an application-programming interface (API), a library, and/or other computer-program product.

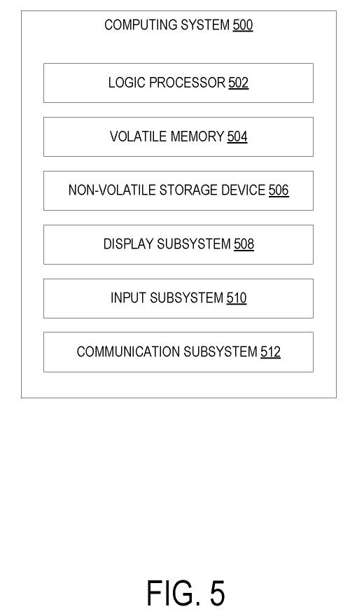

FIG. 5 schematically shows a non-limiting embodiment of a computing system 500 that can enact one or more of the methods and processes described above. Computing system 500 is shown in simplified form. Computing system 500 may embody the digitizer 202 described above and illustrated in FIG. 2. Computing system 500 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 500 includes a logic processor 502, volatile memory 504, and a non-volatile storage device 506. Computing system 500 may optionally include a display subsystem 508, input subsystem 510, communication subsystem 512, and/or other components not shown in FIG. 2.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built-in. Non-volatile storage device 506 may include optical memory (e.g., CD, DVD, HD-DVD, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 500 to send and/or receive messages to and/or from other devices via a network such as the Internet.

The following paragraphs provide additional description of the subject matter of the present disclosure. One example includes a method for embedding a digital watermark in a stylus pen ink by a digitizer, the method comprising: detecting a touch from a stylus pen on a display of the digitizer, determining a user identification, wherein the user identification is linked to the digital watermark, and based at least on the touch from the stylus pen on the display, displaying the stylus pen ink on the display, the stylus pen ink embedding the digital watermark as a pattern of pixels. In this example, additionally or alternatively, determining the user identification comprises determining the user identification based at least in part on user biometric data sensed by one or more sensors of the stylus pen. In this example, additionally or alternatively, the user biometric data comprises one or more of a fingerprint pattern, an iris scan, or voice recognition. In this example, additionally or alternatively, the method further comprises encrypting the user biometric data using an encryption protocol. In this example, additionally or alternatively, determining the user identification comprises determining the user identification based at least in part on one or more of user grip pattern analysis data sensed by one or more sensors of the stylus pen or user motion sensor data sensed by one or more sensors of the stylus pen. In this example, additionally or alternatively, the method further comprises encrypting one or more of the user grip pattern analysis data or the user motion sensor data using an encryption protocol. In this example, additionally or alternatively, the method further comprises encrypting the digital watermark using an encryption protocol. In this example, additionally or alternatively, the method further comprises, in a digital watermark setup process, collecting user biometric data, linking the user biometric data to the user identification, generating the digital watermark for the user identification, and storing the digital watermark linked to the user identification. In this example, additionally or alternatively, embedding the digital watermark occurs at each time the user uses the stylus pen to make a stroke.

Another example includes a stylus pen for user recognition and watermark embedding, the stylus pen comprising: one or more biometric sensors to collect biometric data, the one or more biometric sensors comprising a fingerprint sensor, and a communication device for transferring the biometric data collected by the one or more biometric sensors to another device distinct from the stylus pen. In this example, additionally or alternatively, the stylus pen further comprises a grip pattern sensor to collect grip pattern data. In this example, additionally or alternatively, the stylus pen further comprises one or more motion sensors to collect motion sensor data. In this example, additionally or alternatively, the one or more motion sensors comprise one or more inertial motion sensors. In this example, additionally or alternatively, the one or more biometric sensors further comprises one or more of an image sensor or an acoustic sensor.

Another example includes a system for detecting and verifying an embedded watermark in a stylus pen ink, the system comprising: a stylus pen, and a device capable of detecting and verifying the embedded watermark, wherein the device comprises a processor configured to execute instructions to cause the device to, determine whether the device is using an authorized software, wherein the authorized software is authorized to perform detection and verification capabilities; upon determining that the device is using the authorized software, run a detection algorithm to detect the embedded watermark, and upon determining that the device is using the authorized software, run a verification process to verify the embedded watermark. In this example, additionally or alternatively, running the detection algorithm comprising using a discrete wavelet transform (DWT) to detect the embedded watermark. In this example, additionally or alternatively, running the verification process comprising using a hash-based matching algorithm to verify the embedded watermark. In this example, additionally or alternatively, the system further comprises, upon determining that the device is not using the authorized software, block an unauthorized software from detecting and verifying the embedded watermark. In this example, additionally or alternatively, the device further comprises a verification log, wherein a plurality of users can check the verification log to determine if an embedded watermark associated with a specific user profile was embedded in the stylus pen ink. In this example, additionally or alternatively, the processor is further configured to execute instructions to cause the device to, upon determining that the device is using authorized software, verify a plurality of embedded watermarks including the embedded watermark, each embedded watermark of the plurality of embedded watermarks being embedded in a different stylus pen ink stroke.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for embedding a digital watermark in a stylus pen ink by a digitizer, the method comprising:
detecting a touch from a stylus pen on a display of the digitizer,
determining a user identification, wherein the user identification is linked to the digital watermark, and
based at least on the touch from the stylus pen on the display, displaying the stylus pen ink on the display, the stylus pen ink embedding the digital watermark as a pattern of pixels.

2. The method of claim 1, wherein determining the user identification comprises determining the user identification based at least in part on user biometric data sensed by one or more sensors of the stylus pen.

3. The method of claim 2, wherein the user biometric data comprises one or more of a fingerprint pattern, an iris scan, or voice recognition.

4. The method of claim 2, further comprising encrypting the user biometric data using an encryption protocol.

5. The method of claim 1, wherein determining the user identification comprises determining the user identification based at least in part on one or more of user grip pattern analysis data sensed by one or more sensors of the stylus pen or user motion sensor data sensed by one or more sensors of the stylus pen.

6. The method of claim 5, further comprising encrypting one or more of the user grip pattern analysis data or the user motion sensor data using an encryption protocol.

7. The method of claim 1, further comprising encrypting the digital watermark using an encryption protocol.

8. The method of claim 1, further comprising, in a digital watermark setup process, collecting user biometric data, linking the user biometric data to the user identification, generating the digital watermark for the user identification, and storing the digital watermark linked to the user identification.

9. The method of claim 1, wherein embedding the digital watermark occurs at each time the user uses the stylus pen to make a stroke.

10. A stylus pen for user recognition and watermark embedding, the stylus pen comprising:
one or more biometric sensors to collect biometric data, the one or more biometric sensors comprising a fingerprint sensor, and
a communication device for transferring the biometric data collected by the one or more biometric sensors to another device distinct from the stylus pen.

11. The stylus pen of claim 10, furthering comprising a grip pattern sensor to collect grip pattern data.

12. The stylus pen of claim 10, further comprising one or more motion sensors to collect motion sensor data.

13. The stylus pen of claim 12, wherein the one or more motion sensors comprise one or more inertial motion sensors.

14. The stylus pen of claim 10, wherein the one or more biometric sensors further comprises one or more of an image sensor or an acoustic sensor.

15. A system for detecting and verifying an embedded watermark in a stylus pen ink, the system comprising:
a stylus pen, and
a device capable of detecting and verifying the embedded watermark, wherein the device comprises a processor configured to execute instructions to cause the device to,
determine whether the device is using an authorized software, wherein the authorized software is authorized to perform detection and verification capabilities;
upon determining that the device is using the authorized software, run a detection algorithm to detect the embedded watermark, and
upon determining that the device is using the authorized software, run a verification process to verify the embedded watermark.

16. The system of claim 15, wherein running the detection algorithm comprising using a discrete wavelet transform (DWT) to detect the embedded watermark.

17. The system of claim 15, wherein running the verification process comprising using a hash-based matching algorithm to verify the embedded watermark.

18. The system of claim 15, further comprising, upon determining that the device is not using the authorized software, block an unauthorized software from detecting and verifying the embedded watermark.

19. The system of claim 15, wherein the device further comprises a verification log, wherein a plurality of users can check the verification log to determine if an embedded watermark associated with a specific user profile was embedded in the stylus pen ink.

20. The system of claim 15, wherein the processor is further configured to execute instructions to cause the device to, upon determining that the device is using authorized software, verify a plurality of embedded watermarks including the embedded watermark, each embedded watermark of the plurality of embedded watermarks being embedded in a different stylus pen ink stroke.
